(19) United States
(12) Patent Application Publication
(10) Pub. No.: US 2024/0400346 A1
(43) Pub. Date: Dec. 5, 2024

(54) ROLLER UNIT OF FILAMENT WINDING MACHINE

(71) Applicants: Murata Machinery, Ltd., Kyoto-shi (JP); Toyota Jidosha Kabushiki Kaisha, Toyota-shi (JP)

(72) Inventors: Motohiro Tanigawa, Kyoto-shi (JP); Masatsugu Goyude, Kyoto-shi (JP); Toshihiro Matsui, Kyoto-shi (JP); Hirotaka Wada, Kyoto-shi (JP); Yoshihiro Kino, Kyoto-shi (JP); Hidehiro Takeoka, Kyoto-shi (JP); Yasuhiro Sakanashi, Kyoto-shi (JP); Dai Shimizube, Kyoto-shi (JP); Daigoro Nakamura, Kyoto-shi (JP); Yoshinori Miura, Toyota-shi (JP)

(73) Assignees: Murata Machinery, Ltd., Toyota-shi (JP); Toyota Jidosha Kabushiki Kaisha, Toyota-shi (JP)

(21) Appl. No.: 18/676,862

(22) Filed: May 29, 2024

(30) Foreign Application Priority Data
May 30, 2023 (JP) 2023-088625

(51) Int. Cl. B65H 75/28

(52) U.S. Cl. CPC B65H 75/285; B65H 2701/31

(57) ABSTRACT

A roller unit in which loosening of a fiber bundle is suppressed and the fiber bundle is easily held and released is provided. A roller unit 70 includes a guide roller 71 onto which a fiber bundle F is placed and a first yarn holding member 82 and a second yarn holding member 83 attached to a leading end portion of the guide roller 71 in the axial direction. The first yarn holding member 82 and the second yarn holding member 83 are arranged to be able to make contact with each other and to be separated from each other, and can hold the fiber bundle F by sandwiching the same.

### CROSS-REFERENCE TO RELATED APPLICATION

This application claims the benefit of Japanese Pat. App. No. 2023-088625, filed on May 30, 2023, which application is incorporated herein by reference in its entirety.

### BACKGROUND

This disclosure relates to a roller unit provided in a filament winding device.

Japanese Laid-Open Patent Publication No. 2021-37702 discloses a filament winding device to wind fiber bundles pulled out from bobbins onto the circumferential surface of a cylindrical liner. The filament winding device has a hoop winding unit to perform hoop-winding by which a fiber bundle is wound in a direction substantially perpendicular to the axial direction of the liner, and a helical winding unit to perform helical-winding by which a fiber bundle is wound in a direction substantially parallel to the axial direction of the liner. In the hoop winding unit and the helical winding unit, guide rollers are provided to guide fiber bundles pulled out from bobbins to the liner. Guide rollers may also be provided in units other than these winding units.

The fiber bundle pulled out from the bobbin is placed onto each guide roller by an operator. More specifically, the fiber bundles are placed onto the guide rollers from the upstream side in the running direction of the fiber bundles, while the fiber bundles are pulled by the operator not to loosen.

After a fiber bundle is placed onto a guide roller, an operator may perform an operation for another fiber bundle before further placing a fiber bundle onto a guide roller on the downstream side, in consideration of, for example, the working efficiency. In this regard, if the fiber bundle having already been placed onto the guide roller loosens while the operation is being done, the fiber bundle may be detached from the guide roller. In another example, when a guide roller on the upstream side is remote from a guide roller on the downstream side, an operator may move to a position where a fiber bundle can be easily placed onto the guide roller on the downstream side, after placing a fiber bundle onto the guide roller on the upstream side. In this regard, it is difficult for the operator to move while pulling the fiber bundle not to loosen.

Under this circumstance, to suppress the loosening of the fiber bundle during the above-described operation or the movement of the operator, the operator may temporarily hold, at a given location, a leading end portion of the fiber bundle having already been placed onto a guide roller. Specifically, for example, the fiber bundle is secured to the floor or the device main body by using a tape or a magnet, or the fiber bundle may be tied to a given component. Thereafter, the operator finishes the operation or the movement, and then releases the fiber bundle having been held, and places a fiber bundle onto a guide roller on the downstream side.

In the arrangement above, when the distance between the guide roller onto which the fiber bundle has just been placed and the location where the fiber bundle is held is long, it is difficult to maintain the fiber bundle to be tensioned between the guide roller and the location where the fiber bundle is held. In other words, there is a risk of loosening of the fiber bundle between the guide roller and the location where the fiber bundle is held, and the fiber bundle may be detached from the guide roller where the placing of the fiber bundle has already been done. Furthermore, bringing the fiber bundle to a location remote from the guide roller would be tiresome for the operator.

A fiber bundle may be directly wound onto a guide roller. This arrangement, however, is disadvantageous in that the operator is required to tie the fiber bundle to the guide roller and untie the fiber bundle from the guide roller. These operations are significantly tiresome for the operator, and the fiber bundle may loosen while the operator ties and unties the fiber bundle.

It could therefore be helpful to provide a roller unit in which loosening of a fiber bundle is suppressed and the fiber bundle is easily held and released.

### SUMMARY

### We Provide:

A roller unit that comprises: a guide roller onto which a fiber bundle is placed; and paired yarn holding members which are attached to a leading end portion in an axial direction of the guide roller, the paired yarn holding members being capable of making contact with each other and being separated from each other, and being capable of holding the fiber bundle by sandwiching the fiber bundle.

The paired yarn holding members are attached to the leading end portion of the guide roller. Because the yarn holding members holding the fiber bundle are provided in the close vicinity of the guide roller, it is easy to maintain the fiber bundle to be tensioned between the guide roller and the yarn holding members. As a result, it is possible to suppress the loosening of the fiber bundle between the guide roller and the yarn holding members. Furthermore, the operator is not required to bring the fiber bundle to a location remote from the guide roller, and hence the burden on the operator is reduced. Furthermore, the fiber bundle is held by being sandwiched between the paired yarn holding members. Therefore, there is no need for the operator to tie and untie the fiber bundle. The burden on the operator is therefore reduced. With the arrangement described above, loosening of the fiber bundle is suppressed and the fiber bundle is easily held and released.

In our roller unit, the paired yarn holding members include a first yarn holding member and a second yarn holding member which is capable of making contact with and being separated from the first yarn holding member, the roller unit further comprising a biasing member which is configured to bias the second yarn holding member toward the first yarn holding member.

With this arrangement, the operator can separate the first yarn holding member from the second yarn holding member by pulling the second yarn holding member in the direction opposite to the direction of biasing by the biasing member. Furthermore, by releasing the pulled second yarn holding member, it is possible to move the second yarn holding member toward the first yarn holding member by the biasing force. In this way, it is possible to cause the first yarn holding member and the second yarn holding member to sandwich the fiber bundle therebetween, by a simple operation. Furthermore, by a simple operation, it is possible to release the fiber bundle from between the first yarn holding member and the second yarn holding member.

Our roller unit comprises a biasing force adjusting mechanism which is configured to adjust a biasing force exerted to the second yarn holding member by the biasing member.

To reliably hold the fiber bundle by using the paired yarn holding members, it is desirable to maximize the biasing force exerted to the second yarn holding member by the biasing member. On the other hand, depending on the force exerted by the operator, it is difficult to pull the second yarn holding member when the biasing force is excessively strong. In the arrangement, the biasing force can be adjusted to a level at which the operator can easily pull the second yarn holding member while the biasing force is sufficiently high.

In our roller unit, the second yarn holding member has a protruding portion which protrudes in a direction intersecting with a direction of biasing by the biasing member or a concave portion which is recessed in the direction intersecting with the direction of biasing by the biasing member.

According to this arrangement, as a finger is hooked on the protruding portion or the concave portion, the second yarn holding member is easily pulled in the direction opposite to the direction of biasing the second yarn holding member by the biasing member. On this account, it is possible to smoothly perform the operation of causing the paired yarn holding members to hold the fiber bundle.

In our roller unit, the paired yarn holding members have paired opposing surfaces opposing each other in a predetermined direction, respectively, and at least one of the opposing surface of the other yarn holding member opposing one yarn holding member or the opposing surface of the one yarn holding member opposing the other yarn holding member has an uneven surface.

Because at least one of the paired opposing surfaces has an uneven surface, it is possible to increase the friction force generated between the fiber bundle sandwiched between the paired opposing surfaces and the opposing surface. This makes it difficult for the fiber bundle to drop from between the paired opposing surfaces, allowing the fiber bundle to be further securely held by the first yarn holding members.

In our roller unit, the paired yarn holding members are arranged to be non-rotatable.

According to this arrangement, even if the guide roller unintentionally rotates while the fiber bundle is held by the yarn holding members, the fiber bundle held by the yarn holding members does not rotate together. Therefore, it is possible to avoid the fiber bundle from loosening due to the rotation of the fiber bundle.

### BRIEF DESCRIPTION OF THE DRAWINGS

FIG. 1 is a perspective view showing a filament winding device related to an example of the roller unit described herein.

FIG. 2 is a block diagram showing an electrical structure of the filament winding device.

FIG. 3(a) and FIG. 3(b) are front elevations of a helical winding unit.

FIG. 4 is a perspective view of a roller unit of one example roller unit.

FIG. 5 is a cross section of the roller unit of one example roller unit.

FIG. 6 is a cross section of the roller unit when paired yarn holding members are separated from each other.

FIG. 7 is a cross section of a roller unit of a modification.

FIG. 8 is a cross section of a roller unit of another modification.

### DETAILED DESCRIPTION

### Filament Winding Device

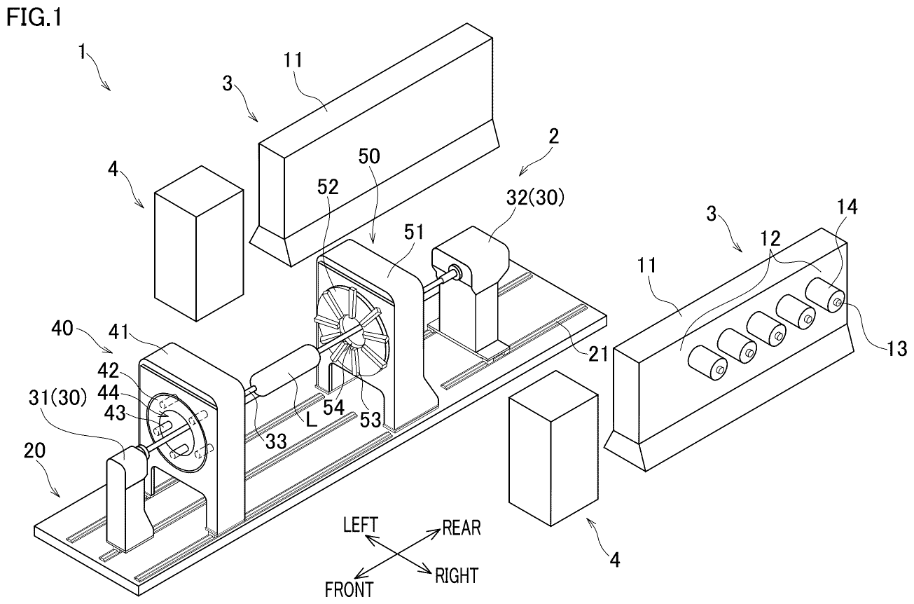

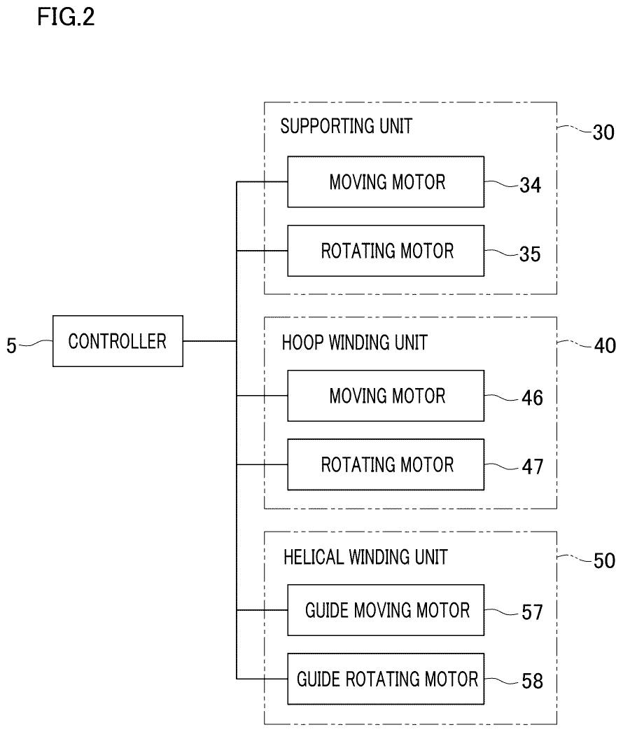

The following will describe a filament winding device to which a roller unit is applied. FIG. 1 is a perspective view showing a filament winding device 1 related to the present example. FIG. 2 is a block diagram of an electric configuration of the filament winding device 1. For convenience of explanation, the directions (front-rear direction and left-right direction) shown in FIG. 1 are defined below. The front-rear direction and the left-right direction are directions parallel to the horizontal direction. The front-rear direction and the left-right direction are orthogonal to each other. Furthermore, the direction orthogonal to both the front-rear direction and the left-right direction will be defined as an up-down direction. In this regard, the up-down direction is a vertical direction in which the gravity acts.

A filament winding device 1 is of a multiple-filaments feeding type, by which plural fiber bundles (not illustrated in FIG. 1) are simultaneously wound onto a liner L. The filament winding device 1 includes a winder 2, creel stands 3, and pretreatment units 4. On the whole, the filament winding device 1 is arranged to be substantially symmetrical in the left-right direction. The winder 2 winds fiber bundles onto a cylindrical liner L. Each fiber bundle is formed by, for example, impregnating a thermosetting or thermoplastic synthetic resin material into a fiber material such as carbon fiber. The shape of the liner L may vary depending on the final product. For example, when the final product is a pressure tank, the liner L having dome portions at both ends of a cylindrical portion as shown in FIG. 1 is used. The materials of the liner L include high-strength aluminum, metal, and resin. After the fiber bundles are wound onto the liner L, a thermosetting process such as baking or a cooling process is performed. As a result, a final product such as a high-strength pressure tank is produced.

The creel stands 3 are positioned on the both sides in the left-right direction of the winder 2, for example. The creel stands 3 are positioned, for example, in the vicinity of a rear end portion of the winder 2 in the front-rear direction. Each creel stand 3 has, for example, a substantially rectangular parallelepiped frame 11 that extends in the front-rear direction. The frame 11 is provided with, for example, one or more bobbin holder group 12. The bobbin holder group 12 is provided to correspond to each of nozzle units 53 of a later-described helical winding unit 50, for example. Each bobbin holder group 12 has a plurality of (five in the present example) bobbin holders 13 aligned in, for example, the front-rear direction. Each bobbin holder 13 has an axis that extends in the left-right direction, for example. Each bobbin holder 13 supports a bobbin 14 on which a fiber bundle is wound, in a rotatable manner. In this example, nine bobbin holder groups 12 are provided, and five bobbins 14 are attached to each bobbin holder group 12. (Therefore 45 bobbins 14 are provided in total.) From the five bobbins 14 belonging to each bobbin holder group 12, five fiber bundles are supplied together. The fiber bundles supplied from the creel stand 3 are wound onto the liner L by the helical winding unit 50. While FIG. 1 show two creel stands 3, the number of the creel stands 3 is not limited to this. In addition, to avoid complication of the drawing, only one of the plural bobbin holder groups 12 is shown in FIG. 1.

The pretreatment units 4 are configured to perform a predetermined pretreatment (e.g., application of a tension) for the fiber bundles. The pretreatment units 4 are, for example, provided between the corresponding creel stands 3 and the helical winding unit 50 (described later) in the running direction of the fiber bundles.

### Winder

The following will describe a more specific arrangement of the winder 2. The winder 2 includes a base 20, supporting units 30 (a first supporting unit 31 and a second supporting unit 32), a hoop winding unit 40, and a helical winding unit 50.

The base 20 supports the supporting units 30, the hoop winding unit 40, and the helical winding unit 50. On the top surface of the base 20, rails 21 are provided to extend in the front-rear direction. The supporting units 30 and the hoop winding unit 40 are movable in the front-rear direction along the rails 21. On the other hand, the helical winding unit 50 is fixed in position relative to the base 20, for example. The first supporting unit 31, the hoop winding unit 40, the helical winding unit 50, and the second supporting unit 32 are provided in this order from the front side to the rear side.

The supporting units 30 include the first supporting unit 31 and the second supporting unit 32. The first supporting unit 31 is positioned forward of the hoop winding unit 40. The second supporting unit 32 is positioned rearward of the helical winding unit 50. Through a supporting shaft 33 which extends in the axial direction of the liner L (i.e., in the front-rear direction), the supporting units 30 support the liner L so that the liner Lis rotatable about the shaft. The supporting units 30 include a moving motor 34 and a rotating motor 35 (see FIG. 2). The moving motor 34 moves the supporting units 30 (the first supporting unit 31 and the second supporting unit 32) in the front-rear direction along the rails 21. The rotating motor 35 rotates the supporting shaft 33 so that the liner L is rotated about the shaft. The operations of the moving motor 34 and the rotating motor 35 are controlled by a controller 5.

The hoop winding unit 40 is configured to perform hoop-winding onto the circumferential surface of the liner L. The hoop-winding is a way of winding the fiber bundles onto the liner L in a direction substantially orthogonal to the axial direction of the liner L. The hoop winding unit 40 includes, for example, a main body 41, a rotation member 42, and plural (five in the present example) bobbin holders 43. The main body 41 is movable in the front-rear direction along the rails 21. The rotation member 42 is an annular member with a passing hole 44 formed to allow the liner L to pass through. The rotation member 42 is supported by the main body 41 to be rotatable about the axis of the liner L. The bobbin holders 43 are attached to the rotation member 42 at regular intervals in the circumferential direction. Each bobbin holder 43 has a rotation shaft extending in the front-rear direction and supports a bobbin (not illustrated) on which a fiber bundle is wound, in a rotatable manner.

The hoop winding unit 40 includes a moving motor 46 and a rotating motor 47 (see FIG. 2). The moving motor 46 moves the main body 41 in the front-rear direction along the rails 21. The rotating motor 47 rotates the rotation member 42 about the axis of the liner L. The operations of the moving motor 46 and the rotating motor 47 are controlled by the controller 5. When the hoop-winding is performed, the controller 5 rotates the rotation member 42 while causing the main body 41 to reciprocate along the rails 21. Because of this, the fiber bundles are taken out from the respective bobbins rotating around the liner L, and are simultaneously hoop-wound onto the circumferential surface of the liner L.

The helical winding unit 50 is configured to perform helical-winding onto the circumferential surface of the liner L. The helical winding is a way of winding the fiber bundles onto the liner L in a direction substantially parallel to the axial direction of the liner L. The helical winding unit 50 includes, for example, a main body 51, a frame member 52, and plural (nine in the present example) nozzle units 53. The main body 51 is fixed to the base 20, for example. The frame member 52 is an annular member with a passing hole 54 formed to allow the liner L to pass through. The frame member 52 is supported by the main body 51. The nozzle units 53 are radially arranged around the axis of liner L. Each nozzle unit 53 is attached to the frame member 52.

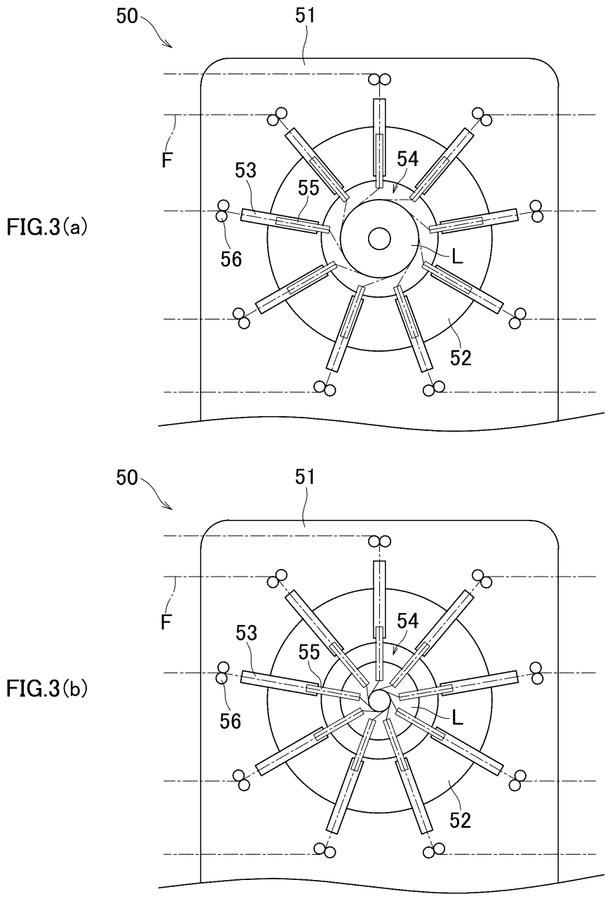

FIG. 3(a) and FIG. 3(b) are front elevations of the helical winding unit 50. To be more specific, FIG. 3(a) shows a situation when fiber bundles F are wound onto the cylindrical portion of the liner L. FIG. 3(b) shows a situation when fiber bundles F are wound onto the dome portion of the liner L. The nozzle unit 53 includes a guide member 55 guiding the fiber bundle F to the liner L. The guide member 55 extends in a radial direction of the liner L (hereinafter, this direction is simply referred to as the radial direction), and is configured to be movable in the radial direction and to be rotatable about a rotational axis extending in the radial direction. Radially outside each nozzle unit 53, a guide roller 56 is provided. The five fiber bundles F taken out from each bobbin holder group 12 of the creel stand 3 are introduced into one of the guide members 55 via the guide roller 56, and then supplied to the liner L from the leading end of the guide member 55.

The helical winding unit 50 includes a guide moving motor 57 and a guide rotating motor 58 (see FIG. 2). The guide moving motor 57 moves the guide members 55 simultaneously in the radial directions. The guide rotating motor 58 rotates the guide members 55 simultaneously about the rotational axis. The operations of the guide moving motor 57 and the guide rotating motor 58 are controlled by the controller 5. When the helical winding is performed, the controller 5 causes the liner L to pass through the passing hole 54 while slowly rotating the liner L about the axis. At the same time, the controller 5 suitably moves the guide member 55 of each nozzle unit 53 in the radial direction while rotating the guide member 55 of each nozzle unit 53 about the rotational axis. As a result, five fiber bundles F are properly pulled out from the leading end of the guide member 55 of each nozzle unit 53, and 45 fiber bundles F in total are simultaneously helical-wound onto the circumferential surface of the liner L.

As described above, in the filament winding device 1, the guide rollers 56 on which the fiber bundles F are wound are provided in the helical winding unit 50. Furthermore, although not illustrated, guide rollers on which fiber bundles F are wound may be provided at another part of the hoop winding unit 40 and the filament winding device 1. Onto each of these guide rollers, five fiber bundles F pulled out each bobbin holder group 12 of the creel stand 3 are placed. More specifically, the fiber bundles F are placed onto the guide rollers in order from the upstream side in the running direction of the fiber bundles F, while the fiber bundles F are pulled by the operator not to loosen.

After a fiber bundle F is placed onto a guide roller, an operator may perform an operation for another fiber bundle F before further placing a fiber bundle F onto a guide roller on the downstream side, in consideration of, for example, the working efficiency. In this regard, if the fiber bundle F having already been placed onto the guide roller loosens while the operation is being done, the fiber bundle F may be detached from the guide roller. In another example, when a guide roller on the upstream side is remote from a guide roller on the downstream side, an operator may move to a position where a fiber bundle F can be easily placed onto the guide roller on the downstream side, after threading a fiber bundle F to the guide roller on the upstream side. It is noted that the expression “move to a position where a fiber bundle F can be easily placed” encompasses both where the operator moves by foot and the operator changes the pose. In this regard, it is difficult for the operator to move while pulling the fiber bundle F not to loosen.

To suppress the loosening of the fiber bundle F during the above-described operation or the movement of the operator, a leading end portion of the fiber bundle F having already been placed onto a guide roller may be temporarily held at a given location of, for example, the floor or the apparatus main body by means of, e.g., a tape or a magnet. However, when the distance between the guide roller onto which the fiber bundle F has just been placed and the location where the fiber bundle F is held is long, the fiber bundle F loosens between the guide roller and the location where the fiber bundle F is held, with the result that the fiber bundle F placed onto the guide roller is detached. The fiber bundle F may be directly wound onto the guide roller. This arrangement, however, is disadvantageous in that the operator is required to tie the fiber bundle F to the guide roller and untie the fiber bundle F from the guide roller. These operations are significantly tiresome for the operator, and the fiber bundle F may be loosened while the operator ties and unties the fiber bundle F.

Under this circumstance, we conceived that the roller unit in which loosening of the fiber bundle F is suppressed and the fiber bundle F is easily held and released.

### Roller Unit

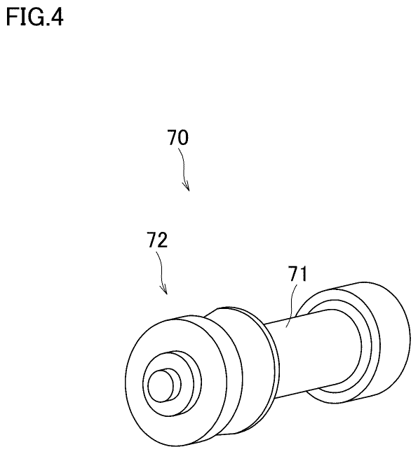

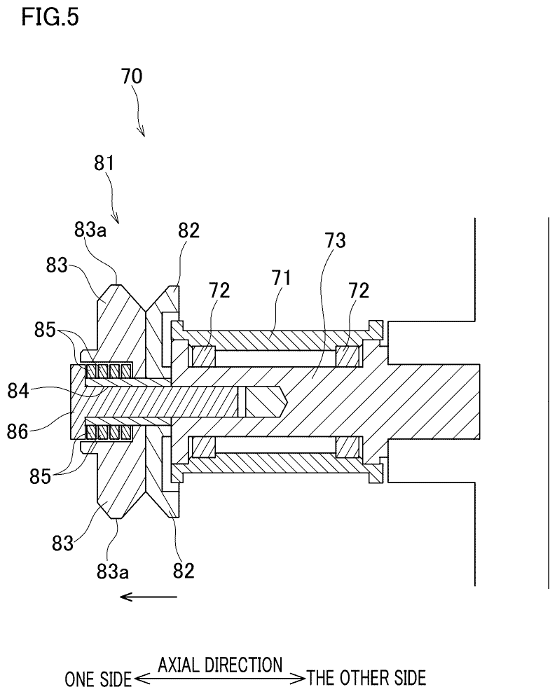

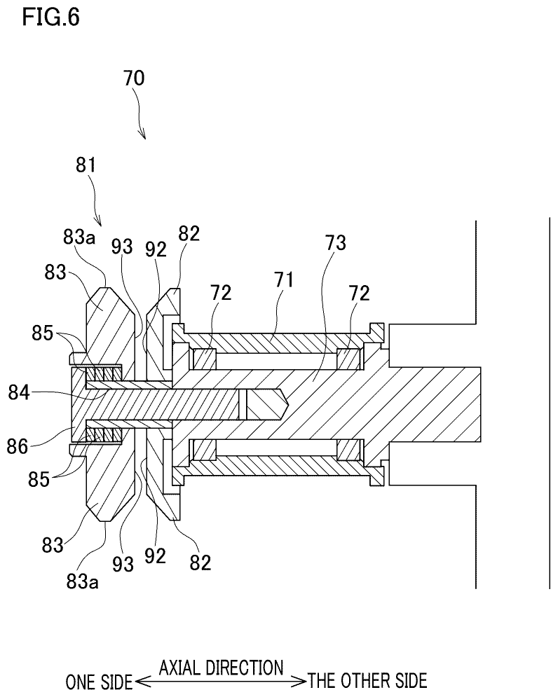

The following will describe a roller unit 70 of the present example with reference to FIG. 4 to FIG. 6. FIG. 4 is a perspective view of the roller unit 70. FIG. 5 is a cross section of the roller unit 70. FIG. 6 is a cross section of the roller unit when paired yarn holding members are separated from each other. The roller unit 70 is provided, for example, in place of one or more of the guide rollers 56 of the helical winding unit 50. The roller unit 70 may not be provided in place of the guide roller 56 of the helical winding unit 50, and may be provided in place of any guide roller provided in the filament winding device 1 of the present example.

As shown in FIG. 4 and FIG. 5, the roller unit 70 includes a guide roller 71 onto which the fiber bundle F is placed and a yarn holding mechanism 81. The guide roller 71 is a cylindrical member and is attached to a roller support shaft 73 to be rotatable through a bearing 72. The roller support shaft 73 is fixed to the main body 41 of the hoop winding unit 40, the main body 51 of the helical winding unit 50, or the pretreatment unit 4, for example.

The yarn holding mechanism 81 is configured to be able to hold the fiber bundle F by sandwiching the same. The yarn holding mechanism 81 is attached to a leading end portion (left end portion of the sheet of FIG. 5) in the axial direction of the guide roller 71. Hereinafter, in the present example, in the axial direction, when the center of the guide roller 71 in the axial direction is the reference point, the leading end portion side of the guide roller 71 is deemed as one side in the axial direction and the base end portion side of the guide roller 71 is deemed as the other side in the axial direction (see FIG. 5 and FIG. 6). The yarn holding mechanism 81 includes a first yarn holding member 82, a second yarn holding member 83, a supporting member 84, an elastic member 85 (biasing member), and a screw 86 (biasing force adjusting mechanism). Note that the first yarn holding member 82 and the second yarn holding member 83 correspond to the paired yarn holding members.

The first yarn holding member 82 and the second yarn holding member 83 are supported by the supporting member 84. The first yarn holding member 82 is provided on the other side of the second yarn holding member 83 in the axial direction. The first yarn holding member 82 is fixed to the supporting member 84. The second yarn holding member 83 is supported by the supporting member 84 to be movable in the axial direction. The second yarn holding member 83 is capable of making contact with and separating from the first yarn holding member 82 by moving in the axial direction. The yarn holding mechanism 81 is capable of holding the fiber bundle F by sandwiching the fiber bundle F between the first yarn holding member 82 and the second yarn holding member 83.

The first yarn holding member 82 and the second yarn holding member 83 have paired opposing surfaces 92 and 93 facing each other in the axial direction (see FIG. 6). More specifically, as shown in FIG. 6, the first yarn holding member 82 has the opposing surface 92 facing one side in the axial direction, whereas the second yarn holding member 83 has the opposing surface 93 facing the other side in the axial direction. At least one of the opposing surface 92 or the opposing surface 93 has an uneven surface. The term “uneven surface” refers to a surface that has a pattern such as leather, pear skin texture, wood texture, rock texture, sand texture, fabric texture, silk texture, geometric pattern and the like, created by, e.g., embossing.

As shown in FIG. 5 and FIG. 6, the second yarn holding member 83 has a protruding portion 83a which protrudes in a direction intersecting with the axial direction. More specifically, the protruding portion 83a protrudes outward in a direction orthogonal to the axial direction from the second yarn holding member 83. In the present example, the protruding portion 83a is tapered so that the width in the axial direction decreases towards the leading end. However, the shape of the protruding portion 83a is not limited to this.

The supporting member 84 is fixedly attached to the leading end of the roller support shaft 73. Therefore, the first yarn holding member 82 and the second yarn holding member 83 are supported not to be rotatable relative to the roller support shaft 73. In other words, the first yarn holding member 82 and the second yarn holding member 83 are arranged not to be rotatable.

The elastic member 85 is a component that biases the second yarn holding member 83 towards the first yarn holding member 82 in the axial direction. In other words, the elastic member 85 is a member that biases the second yarn holding member 83 from one side toward the other side in the axial direction. The clastic member 85 is a spring, for example. An end portion on one side in the axial direction of the elastic member 85 is attached to a screw 86 (described later). The end portion on one side in the axial direction of the elastic member 85 may not be attached to the screw 86, and may be simply provided to be able to make contact with the screw 86. The elastic member 85 is attached to the supporting member 84 through the screw 86.

The screw 86 is a member used to adjust the biasing force exerted to the second yarn holding member 83 by the elastic member 85. The screw 86 is, for example, a so-called male screw which is arranged so that a spiral groove is formed on a cylindrical outer side surface. The screw 86 has a head that is larger in diameter than the part where the groove is formed. The screw 86 is attached to an end portion on one side in the axial direction of the roller unit 70. By tightening the screw 86 from one side to the other side in the axial direction, the elastic member 85 is compressed and the biasing force of the elastic member 85 increases. On the other hand, by loosening the screw 86 from the other side to one side in the axial direction, the elastic member 85 is elongated and the biasing force of the elastic member 85 decreases. The screw 86 has another function of reinforcing the attachment of the first yarn holding member 82, the second yarn holding member 83, and the supporting member 84 to the roller support shaft 73.

### Steps for Causing Yarn Holding Mechanism to Hold and Release Fiber Bundle

With reference to FIG. 5 and FIG. 6, the following will describe steps in which the operator causes the yarn holding mechanism 81 of the roller unit 70 of the present example to hold a fiber bundle F and then causes the yarn holding mechanism 81 to release the fiber bundle F.

To begin with, the operator places a fiber bundle Fonto the guide roller 71 of the roller unit 70. Subsequently, the operator hooks his/her finger onto the protruding portion 83a and pulls the second yarn holding member 83 from the other side towards one side in the axial direction (see a solid arrow in FIG. 5). In other words, the operator pulls the second yarn holding member 83 in the direction opposite to the direction of biasing by the elastic member 85. As a result, the second yarn holding member 83 is separated from the first yarn holding member 82.

Subsequently, the operator brings the fiber bundle F to between the first yarn holding member 82 and the second yarn holding member 83 while pulling the second yarn holding member 83. Thereafter, the operator releases the second yarn holding member 83, with the result that the second yarn holding member 83 is moved toward the first yarn holding member 82 by the biasing force of the clastic member 85. As the fiber bundle F is sandwiched between the first yarn holding member 82 and the second yarn holding member 83, the fiber bundle Fis held by the yarn holding mechanism 81.

While the fiber bundle F is held by the yarn holding mechanism 81, the operator performs an operation for another fiber bundle F and moves to a position where the fiber bundle F can be easily placed onto the guide roller on the downstream side. After completing the operation and the movement described above, the operator releases the fiber bundle F from the yarn holding mechanism 81. At this time, the operator performs similar steps as the steps that cause the yarn holding mechanism 81 to hold the fiber bundle F.

To be more specific, the operator hooks his/her finger onto the protruding portion 83a and pulls the second yarn holding member 83 from the other side towards one side in the axial direction (see a solid arrow in FIG. 5). As a result, the second yarn holding member 83 is separated from the first yarn holding member 82, and the fiber bundle F can be released from between the first yarn holding member 82 and the second yarn holding member 83. After releasing the fiber bundle F, the operator releases the second yarn holding member 83, with the result that the original state, i.e., the state in which the first yarn holding member 82 is in contact with the second yarn holding member 83, is established again.

In this way, the steps that cause the yarn holding mechanism 81 to hold the fiber bundle F and then releasing the fiber bundle F are completed. In the steps described above, the operations are performed in the following order. That is to say, (1) a fiber bundle F is placed onto the guide roller 71, (2) then the fiber bundle F is held by the yarn holding mechanism 81, (3) then the operator performs an operation for another fiber bundle F and moves to a position where the fiber bundle F can be easily placed onto the guide roller on the downstream side, and (4) finally the fiber bundle F is released from the yarn holding mechanism 81. The operations, however, may be performed in a different order. For example, the operations may be performed in the following order. (1) A fiber bundle F is held by the yarn holding mechanism 81, (2) then the operator performs the operation and movement described above, (3) then the fiber bundle F is released from the yarn holding mechanism 81, and (4) finally the fiber bundle F is placed onto the guide roller 71.

### Effects

The roller unit 70 of the present example includes the guide roller 71 onto which the fiber bundle F is placed and the first yarn holding member 82 and the second yarn holding member 83 attached to the leading end portion of the guide roller 71 in the axial direction. The first yarn holding member 82 and the second yarn holding member 83 are arranged to be able to make contact with each other and to be separated from each other, and can hold the fiber bundle F by sandwiching the same. According to the present example, the first yarn holding member 82 and the second yarn holding member 83 are attached to the leading end portion of the guide roller 71. To put it differently, the first yarn holding member 82 and the second yarn holding member 83 holding the fiber bundle F exist in the close vicinity of the guide roller 71. Because of this, it is easy to maintain the fiber bundle F to be tensioned between the guide roller 71 and the first yarn holding member 82 and the second yarn holding member 83. As a result, it is possible to suppress the loosening of the fiber bundle F between the guide roller 71 and the first yarn holding member 82 and the second yarn holding member 83. Furthermore, the operator is not required to bring the fiber bundle F to a location remote from the guide roller 71, and hence the burden on the operator is reduced. Furthermore, the fiber bundle F is held by being sandwiched between the first yarn holding member 82 and the second yarn holding member 83. Therefore, there is no need for the operator to tie and untie the fiber bundle F. The burden on the operator is therefore reduced. Because of the above, the present example makes it possible to suppress the loosening of the fiber bundle F and to easily hold and release the fiber bundle F.

Furthermore, because the first yarn holding member 82 and the second yarn holding member 83 are attached to the leading end portion of the guide roller 71, the following advantages can be obtained. The fiber bundle F is supplied to the liner L through the guide roller 71. Therefore, a position overlapping the guide roller 71 in the axial direction when viewed in the direction orthogonal to the axial direction may be on the running path of the fiber bundle F supplied to the liner L. In this regard, the first yarn holding member 82 and the second yarn holding member 83, which are attached to the leading end portion of the guide roller 71, are positioned out of the running path of the fiber bundle F supplied to the liner L. On this account, the first yarn holding member 82 and the second yarn holding member 83 do not interfere the supply of the fiber bundle F to the liner L.

Furthermore, the roller unit 70 of the present example includes the elastic member 85 that biases the second yarn holding member 83 towards the first yarn holding member 82. With this arrangement, the operator can separate the first yarn holding member 82 from the second yarn holding member 83 by pulling the second yarn holding member 83 in the direction opposite to the direction of biasing by the elastic member 85. Furthermore, by releasing the pulled second yarn holding member 83, it is possible to move the second yarn holding member 83 toward the first yarn holding member 82 by the biasing force. In this way, it is possible to cause the first yarn holding member 82 and the second yarn holding member 83 to sandwich the fiber bundle F therebetween, by a simple operation. Furthermore, by a simple operation, it is possible to release the fiber bundle F from between the first yarn holding member 82 and the second yarn holding member 83.

The roller unit 70 of the present example includes the screw 86 that is a member used to adjust the biasing force exerted to the second yarn holding member 83 by the elastic member 85. To reliably hold the fiber bundle F by using the first yarn holding member 82 and the second yarn holding member 83, it is desirable to maximize the biasing force exerted to the second yarn holding member 83 by the elastic member 85. On the other hand, depending on the force exerted by the operator, it is difficult to pull the second yarn holding member 83 when the biasing force is excessively strong. In the present example, the biasing force can be adjusted to a level at which the operator can easily pull the second yarn holding member 83 while the biasing force is sufficiently high.

Furthermore, in the roller unit 70 of the present example, the second yarn holding member 83 has the protruding portion 83a that protrudes in a direction intersecting with the direction of biasing by the elastic member 85. According to this arrangement, as a finger is hooked on the protruding portion 83a, the second yarn holding member 83 is easily pulled in the direction opposite to the direction of biasing the second yarn holding member 83 by the elastic member 85. On this account, it is possible to smoothly perform the operation of causing the first yarn holding member 82 and the second yarn holding member 83 to hold the fiber bundle F.

In the roller unit 70 of the present example, the first yarn holding member 82 and the second yarn holding member 83 have paired opposing surfaces 92 and 93 facing each other in the axial direction. At least one of the opposing surface 92 or the opposing surface 93 has an uneven surface. Because at least one of the opposing surface 92 or the opposing surface 93 has an uneven surface, it is possible to increase the friction force generated between the fiber bundle F sandwiched between the paired opposing surfaces 92 and 93 and either the opposing surface 92 or the opposing surface 93. This makes it difficult for the fiber bundle F to drop from between the opposing surfaces 92 and 93, allowing the fiber bundle F to be further securely held by the first yarn holding member 82 and the second yarn holding member 83.

Furthermore, in the roller unit 70 of the present example, the first yarn holding member 82 and the second yarn holding member 83 are arranged to be non-rotatable. According to this arrangement, even if the guide roller 71 unintentionally rotates while the fiber bundle F is held by the first yarn holding member 82 and the second yarn holding member 83, the fiber bundle F held by the first yarn holding member 82 and the second yarn holding member 83 does not rotate together. Therefore, it is possible to avoid the fiber bundle F from loosening due to the rotation of the fiber bundle F.

### Modifications

The following will describe modifications of the above-described example. The members identical with those in the example above will be denoted by the same reference numerals, and the explanations thereof are not repeated.

In the above example, as the second yarn holding member 83 moves in the axial direction, the first yarn holding member 82 and the second yarn holding member 83 are able to make contact with each other and to separate from each other. Alternatively, as the first yarn holding member 82 moves in the axial direction, the first yarn holding member 82 and the second yarn holding member 83 may be able to make contact with each other and separate from each other. Alternatively, as both of the first yarn holding member 82 and the second yarn holding member 83 move in the axial direction, the first yarn holding member 82 and the second yarn holding member 83 may be able to make contact with each other and to separate from each other.

In the above example, the direction in which the elastic member 85 biases the second yarn holding member 83 is the axial direction. Alternatively, the direction in which the elastic member 85 biases the second yarn holding member 83 may intersect with the axial direction.

In the example above, the spring is taken as an example of the elastic member 85. Alternatively, the elastic member 85 may be, for example, a member made of resin with elasticity. In the example above, the elastic member 85 is employed as the biasing member that biases the second yarn holding member 83 towards the first yarn holding member 82. However, the biasing member is not limited to this arrangement. For example, a magnet may be used as the biasing member. Specifically, the first yarn holding member 82 is made of iron, and the second yarn holding member 83 is made of a magnetic material. With this arrangement, the second yarn holding member 83 is biased by its magnetic force toward the first yarn holding member 82. In other words, the second yarn holding member 83 has a function of the biasing member. Both of the first yarn holding member 82 and the second yarn holding member 83 may be magnetic. In this example, the first yarn holding member 82 and the second yarn holding member 83 are arranged to attract each other by magnetic forces.

In the example above, the screw 86 is equivalent to the biasing force adjusting mechanism, and the biasing force exerted to the second yarn holding member 83 by the elastic member 85 is adjusted by tightening or loosening the screw 86. The biasing force adjusting mechanism, however, is not limited to this arrangement. For example, when using a magnet as the biasing member as described above, the biasing force adjusting mechanism may be a mechanism to adjust the magnetic force of the magnet. The biasing force adjusting mechanism may not be provided.

In the example above, the roller unit 70 includes the biasing member (elastic member 85) that biases the second yarn holding member 83 towards the first yarn holding member 82. However, the roller unit 70 may not include the biasing member. For example, the following structure may be adopted. The first yarn holding member 82 and the second yarn holding member 83 are two claw members that are arranged to engage with each other. When the first yarn holding member 82 and the second yarn holding member 83 hold the fiber bundle F, the claw of the first yarn holding member 82 is engaged with the claw of the second yarn holding member 83 while the first yarn holding member 82 and the second yarn holding member 83 pinch the fiber bundle F therebetween. When the fiber bundle F is released from the first yarn holding member 82 and the second yarn holding member 83 arranged as described above, the engagement of the claw of the first yarn holding member 82 and the claw of the second yarn holding member 83 is canceled.

The following arrangement may be employed as an example of an arrangement in which the roller unit 70 does not include the biasing member. A protruding part extending in the axial direction is formed in the first yarn holding member 82, whereas a hole part in which the protruding part can be inserted is formed in the second yarn holding member 83. By fitting the protruding part of the first yarn holding member 82 into the hole part of the second yarn holding member 83, the contact state between the first yarn holding member 82 and the second yarn holding member 83 is fixed. When the first yarn holding member 82 and the second yarn holding member 83 hold the fiber bundle F, the protruding part of the first yarn holding member 82 is fitted with the hole part of the second yarn holding member 83 while the first yarn holding member 82 and the second yarn holding member 83 pinch the fiber bundle F therebetween. When the fiber bundle F is released from the first yarn holding member 82 and the second yarn holding member 83 arranged as described above, the protruding part of the first yarn holding member 82 is pulled out from the hole part of the second yarn holding member 83.

In the example above, the first yarn holding member 82 and the second yarn holding member 83 have paired opposing surfaces 92 and 93 facing each other in the axial direction. Alternatively, the first yarn holding member 82 and the second yarn holding member 83 may have paired opposing surfaces 92 and 93 facing each other in a direction intersecting with the axial direction. In the example above, at least one of the opposing surface 92 or the opposing surface 93 has an uneven surface. Alternatively, neither the opposing surface 92 nor the opposing surface 93 may have an uneven surface.

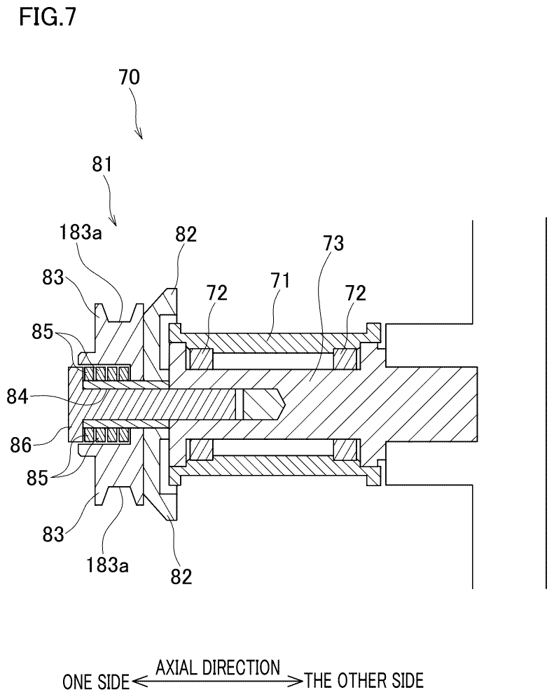

In the example above, the second yarn holding member 83 has a protruding portion 83a which protrudes in a direction intersecting with the axial direction. Alternatively, the second yarn holding member 83 may have a concave portion that is recessed in a direction intersecting with the axial direction. For example, as shown in FIG. 7, the second yarn holding member 83 has a concave portion 183a that is recessed towards the inside of the second yarn holding member 83 in a direction orthogonal to the axial direction. With this the concave portion 183a, as a finger is hooked in the concave portion 183a, the second yarn holding member 83 is easily pulled in the direction opposite to the direction of biasing the second yarn holding member 83 by the elastic member 85. On this account, it is possible to smoothly perform the operation of causing the first yarn holding member 82 and the second yarn holding member 83 to hold the fiber bundle F. The shape of the concave portion 183a is not limited to the shape shown in FIG. 7.

In the example above, the first yarn holding member 82 and the second yarn holding member 83 are arranged to be non-rotatable. Alternatively, the first yarn holding member 82 and the second yarn holding member 83 may be arranged to be rotatable. To be more specific, a supporting member 84 supporting the first yarn holding member 82 and the second yarn holding member 83 may be attached to the leading end of the roller support shaft 73 to be rotatable. Alternatively, the supporting member 84 may be directly attached to the leading end of the guide roller 71.

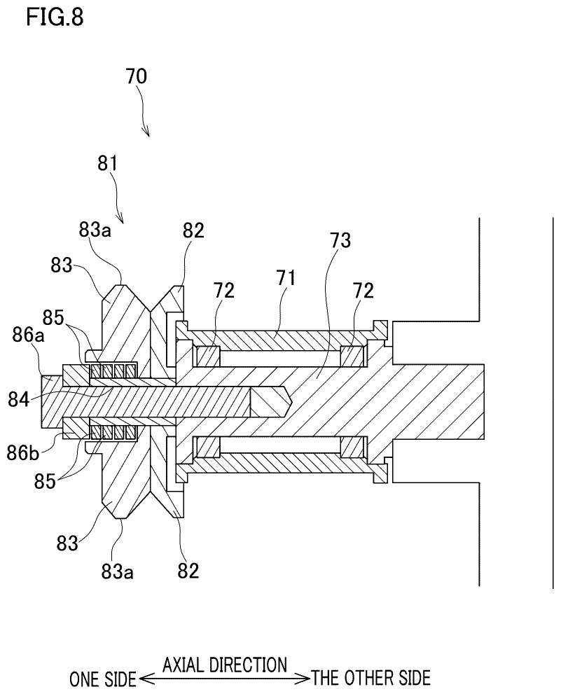

In the example above, the screw 86 as the biasing force adjusting mechanism is attached to an end portion on one side in the axial direction of the roller unit 70. Alternatively, a nut may be provided between the screw 86 and the supporting member 84. For example, as shown in FIG. 8, a screw 86a and a nut 86b are attached to an end portion on one side of the roller unit 70 in the axial direction. The nut 86b is provided between the head of the screw 86a and the supporting member 84 in the axial direction. By tightening the nut 86b from one side to the other side in the axial direction in addition to the tightening of the screw 86a, the elastic member 85 is further compressed and the biasing force of the elastic member 85 exerted to the second yarn holding member 83 further increases. To decrease the biasing force of the elastic member 85, the nut 86b is loosened from the other side to the one side in the axial direction.

With the nut 86b, the following effect can be achieved. For example, when only the screw 86 is provided as in the example above, the screw 86 may loosen as a result of continuous use of the roller unit 70. Consequently, the force of the screw 86 reinforcing the attachment of the first yarn holding member 82, the second yarn holding member 83, and the supporting member 84 to the roller support shaft 73 may be decreased. The loosening of the screw 86a is suppressed by the presence of the nut 86b. Therefore, even if the roller unit 70 is continuously used, the screw 86a is less likely to loosen. It is therefore possible to suppress the decrease of the force of the screw 86 reinforcing the attachment of the first yarn holding member 82, the second yarn holding member 83, and the supporting member 84 to the roller support shaft 73.

What is claimed is:

1. A roller unit comprising:
a guide roller onto which a fiber bundle may be placed; and
paired yarn holding members which are attached to a leading end portion in an axial direction of the guide roller,
the paired yarn holding members being capable of making contact with each other and being separated from each other, and being capable of holding the fiber bundle by sandwiching the fiber bundle.

2. The roller unit according to claim 1, wherein,
the paired yarn holding members include a first yarn holding member and a second yarn holding member which is capable of making contact with and being separated from the first yarn holding member,
the roller unit further comprising a biasing member which is configured to bias the second yarn holding member toward the first yarn holding member.

3. The roller unit according to claim 2, further comprising a biasing force adjusting mechanism which is configured to adjust a biasing force exerted to the second yarn holding member by the biasing member.

4. The roller unit according to claim 2, wherein, the second yarn holding member has a protruding portion which protrudes in a direction intersecting with a direction of biasing by the biasing member or a concave portion which is recessed in the direction intersecting with the direction of biasing by the biasing member.

5. The roller unit according to claim 1, wherein,
the paired yarn holding members have paired opposing surfaces opposing each other in a predetermined direction, respectively, and
at least one of the opposing surface of the other yarn holding member opposing one yarn holding member or the opposing surface of the one yarn holding member opposing the other yarn holding member has an uneven surface.

6. The roller unit according to claim 1, wherein, the paired yarn holding members are arranged to be non-rotatable.

7. The roller unit according to claim 4, wherein,
the paired yarn holding members have paired opposing surfaces opposing each other in a predetermined direction, respectively, and
at least one of the opposing surface of the other yarn holding member opposing one yarn holding member or the opposing surface of the one yarn holding member opposing the other yarn holding member has an uneven surface.

8. The roller unit according to claim 7, wherein, the paired yarn holding members are arranged to be non-rotatable.

9. The roller unit according to claim 4, wherein, the paired yarn holding members are arranged to be non-rotatable.
